(19) United States
(12) Patent Application Publication
(10) Pub. No.: US 2015/0286211 A1
(43) Pub. Date: Oct. 8, 2015

(54) METHOD AND MACHINE SYSTEM FOR POSITIONING TWO MOVABLE UNITS IN A RELATIVE POSITION TO EACH OTHER

(71) Applicant: STIWA HOLDING GMBH, Attnang-Puchheim (AT)

(72) Inventors: Walter Leopold Sticht, Attnang-Puchheim (AT); Johann Kritzinger, Frankenburg (AT); Christian Mersnik, Attnang-Puchheim (AT); Reinhard Schlager, Fornach (AT)

(73) Assignee: STIWA HOLDING GMBH, Attnang-Puchheim (AT)

(21) Appl. No.: 14/441,358

(22) PCT Filed: Nov. 7, 2013
(86) PCT No.: PCT/AT2013/050213

§ 371 Date: May 7, 2015

(30) Foreign Application Priority Data
Nov. 8, 2012 (AT) A 50501/2012
Aug. 13, 2013 (AT) A 50501/2013

(51) Int. Cl. G05B 19/418; B25J 9/16

(52) U.S. Cl. CPC G05B 19/4182; B25J 9/1687

(57) ABSTRACT

A method positions a first movable unit of a machine system and a second movable unit of the machine system in a definable relative position to each other. For this purpose, the first movable unit is moved to a first position within a first travel space with the aid of a first measuring system. The second movable unit is moved to a second position within a second travel space with the aid of a second measuring system. The first movable unit and/or the second movable unit is moved to the predetermined relative position to each other with the aid of a third measuring system. A machine system carries out the method.

The invention relates to a method for positioning a first movable unit of a machine system and a second movable unit of the machine system in a predeterminable relative position to one another, wherein
the first movable unit is moved to a first position within a first movement space, using a first measurement system, and
the second movable unit is moved to a second position within a second movement space, using a second measurement system.

Furthermore, the invention relates to a machine system comprising
a first movable unit that can be moved in a first movement space, using at least a first drive,
a first measurement system assigned to the first movable unit, using which system the first movable unit can be positioned in any desired predeterminable position in the first movement space,
a second movable unit that can be moved in a second movement space, using at least a second drive, wherein the first movement space and the second movement space demonstrate an overlap region, and
a second measurement system assigned to the second movable unit, using which system the second movable unit can be positioned in any desired predeterminable position in the second movement space.

A method and a machine system of the stated type are fundamentally known, for example in the form of a machine tool, the processing head of which, configured as a first movable unit, and the tool support of which, configured as second movable units, move into a tool changing position. In this connection, the processing head is positioned using a first measurement system, which comprises incremental or absolute value encoders at the movement axes, for example. The tool supports can be disposed on a chain, for example, which chain is positioned using a second measurement system, which can also comprise incremental or absolute value encoders. Because the processing robots and the tool changing system are disposed on a common frame or stand in a predetermined position relative to one another by way of their set-up, a specific relative position of the processing head relative to the tool support can be moved to by means of predetermining a first position in the first measurement system and a second position in the second measurement system, in order to carry out a tool change.

Unfortunately, it has been shown in practice that the position of a processing robot and of a tool changing system relative to one another can change over time. Reasons for this are temperature-related deformations or also plastic deformation of the components involved, as well as aging phenomena of the measurement systems and sensor drift. In this connection, the deviations can become so great that the tool or the processing head is damaged during a tool change, or a tool change can no longer be carried out at all. For this reason, such machine systems or their measurement systems are calibrated at regular intervals, after having been set up or also during operation.

The term “calibration” refers, in general, to a measurement process for determining and documenting the deviation or a measurement device or a dimensional standard from a reference device or a reference dimensional standard. In this connection, the reference device or the reference dimensional standard is also referred to as “normal.” The deviation determined is taken into consideration during the subsequent use of the measurement device, in order to correct the values displayed.

As a result of the calibration of the first and the second measurement system, the relative position of the processing head relative to the tool support, determined by means of the first and the second position, agrees with the desired relative position once again.

It is disadvantageous, in this connection, that the calibration process, which makes measuring of the machine system necessary, is very complicated. Furthermore, a specific precision between two calibration procedures cannot be guaranteed.

A further disadvantage of the known machine system is also that the entire first and second measurement system must have a relatively high precision, which is guided by the required precision of the relative position to be assumed. In the case of large tool changing magazines, in particular, the measurement system needed for correct positioning of the tool supports can cause significant costs.

In addition the precision of the relative position that can be achieved clearly lies below the precision of the first and the second measurement system, because of error addition. If the first measurement system, for example, has a precision/resolution of +/−0.1 mm, and the second measurement system has a precision/resolution of +/−0.2 mm, then a precision/resolution of +/−0.3 mm can be achieved for the predetermined relative position.

It is therefore a task of the present invention to indicate an improved method and an improved machine system for positioning two movable units in a relative position to one another. In particular, calibration procedures are supposed to be avoided, or the intervals between them are at least supposed to be lengthened, and the precision/resolution of the relative position is supposed to be increased, wherein the precision/resolution of the first and/or second measurement system does not need to be increased or can actually be reduced.

The task of the invention is accomplished with a method of the type stated initially, in which
the first movable unit and/or the second movable unit is/are moved into the said predetermined relative position, using a third measurement system.

The task of the invention is furthermore accomplished with a machine system of the type stated initially, additionally comprising
a third measurement system that is set up for determining a relative position between the first movable unit and the second movable unit.

The precision that can be achieved for the relative position can be significantly increased by including a third measurement system. The work steps that take place in the machine system thereby become more precise and more reliable.

A preferred method variant is characterized in that the first position and the second position lie within a detection region of the third measurement system.

A preferred machine system is characterized in that the detection region of the third measurement system lies in the said overlap region.

In this manner, the precision that can be achieved for the relative position is dependent (only) on the third system. If the first to third measurement systems have a precision/resolution of +/−0.1 mm, for example, then a precision/resolution of +/−0.1 mm can be achieved for the predetermined relative position. Error addition therefore does not lead to a reduced precision/resolution of +/−0.2 mm, as it does in the state of the art.

Supplementally, it should be noted that “resolution” in general indicates the smallest displayable difference between two measurement values. “Precision” on the other hand indicates the difference between measured value and actual value, in general. High resolution is therefore not necessarily an indication of great precision, and vice versa. In general, the precision can be indicated as the difference between measured value and true value or as the ratio of the two (for example relative precision in percent).

By means of the proposed measures, calibration procedures can furthermore be avoided or the intervals between them can at least be lengthened, without the precision that can be achieved for the relative position suffering as a result, particularly also not between two calibration procedures. A calibration procedure of the first and/or second measurement device can, however, become necessary if the first and/or the second position no longer lies/lie in the measurement range of the third measurement device. A calibration procedure of the third measurement device can become necessary if the third measurement device is no longer sufficiently accurate.

In the case of the proposed method and the proposed machine system, adherence to an absolute dimension of the first and/or second measurement device to achieve a specific relative position between the first and the second movable unit is actually unimportant. In general, it is sufficient if the relative position predetermined by the first and second position or the relative position ultimately reached lies “somewhere” in the measurement range of the third measurement system. The use of reference standards, as is the case in a calibration procedure, is not necessary.

Further advantageous embodiments and further developments of the invention are evident from the dependent claims and from the description in conjunction with the figures.

It is advantageous if
at least one first drive assigned to the first movable unit is coupled with the first measurement system, for moving to the first position,
at least one second drive assigned to the second movable unit is coupled with the second measurement system, for moving to the second position,
the first drive and/or the second drive is/are coupled with the third system, for moving to the relative position, particularly exclusively with the third measurement system.

In the same manner, a machine system is advantageous, comprising means for coupling
the first drive with the third measurement system, alternatively/additionally to the first measurement system, and/or
the second drive with the third measurement system, alternatively/additionally to the second measurement system. In this variant of the method, the first and the second position are therefore moved to using the first and the second measurement system. From there, the predetermined relative position is moved to using the third measurement system. For this purpose, it is possible that correction values for the first and/or third measurement system are determined using the third measurement system, and/or the corrected first and/or second position is moved to using the first and/or the second measurement system. It is advantageous that drive regulation of the machine system practically does not need to be changed for this purpose, because using the third measurement system, only adapted desired values for the first and/or second measurement system are predetermined. It is also conceivable, however, that the drives of the machine system are uncoupled from the first and/or second measurement system and, instead, coupled with the third measurement system. As a result, position regulation then takes place directly by way of the third measurement system. Finally, mixed forms of the two stated methods are also possible. For example, not only the values determined by the first/second measurement system but also the values determined by the third measurement system can be used for position regulation. Under some circumstances, the positioning precision can be significantly improved in this way, as compared with a method in which only the first/second measurement system or only the third measurement system is used. As an example, it is assumed, once again, that all the measurement systems have a precision/resolution of +/−0.1 mm. If the “scales” of the first/second measurement system and of the third measurement system are offset from one another, particularly by 0.05 mm, then the precision/resolution can be increased to +/−0.05 mm by means of the simultaneous use of the measurement values of the first/second measurement system and of the third measurement system.

It is particularly advantageous if the relative position of the first movable unit to the second movable unit is directly measured by means of the third measurement system. In this way, the deviation of the actual relative position from the desired relative position is maximally as great as the precision/resolution of the third measurement system. If the precision/resolution lies at +/−0.1 mm, for example, the relative position can be determined with a precision/resolution of +/−0.1 mm.

However, it is also advantageous if the relative position of the first movable unit to the second movable unit is determined by means of measuring the position of the first movable unit to a reference point and measuring the position of the second movable unit to this reference point by means of the third measurement system, and subsequently subtracting the two positions. It is advantageous, in this connection, that the third measurement system can be mounted in a fixed location on a frame. In this way, it can be well protected against contamination and damage.

If applicable, possible error addition must be taken into consideration. If the precision/resolution of the third measurement device once again lies at +/−0.1 mm, for example, then the relative position can be determined with a precision/resolution of +/−0.2 mm.

It is furthermore particularly advantageous if the measurement values of the first and/or second measurement system are stored as the future first and/or second position when the predetermined relative position has been reached. The first and second position are therefore not necessarily constant. Instead, the first and/or the second position is constantly re-adjusted, so that the relative position achieved by means of the first and second position is constantly approximated or tracked to the actual relative position determined by the third measurement system. In this manner, it is ensured that the first and the second position cannot “migrate out of” the measurement range of the third measurement system over the course of time, as the result temperature-related or plastic deformations of the components involved, as well as aging phenomena and sensor drift of the first and/or second measurement system. At this point, it should be noted that this procedure does not involve calibration of the first and/or second measurement device, because reaching a specific relative position of the first and the second movable unit to one another is not necessarily bound by a precisely functioning or calibrated first and second measurement system. A correct relative position can be achieved even with an “incorrect” first and second position.

A preferred embodiment is characterized in that the first position and/or the second position lies/lie outside of the detection region of the third measurement system. Such a constellation is particularly suitable for machine systems in which multiple second movable units, particularly workpiece supports, are coupled with one another, for example in the form of a transport chain. By means of detecting the position of a workpiece support, a conclusion can also be drawn regarding the position of the other workpiece supports. From a deviation of the actual position from a desired position of the detected workpiece support at a specific point in time, it can be concluded that other workpiece supports in the same composite also have a corresponding deviation from the desired position. This information can be used to nevertheless reach the predetermined relative position, furthermore at great precision. It is also an advantage of this variant that the third measurement system is not disposed in the common working region of the movable units, taking up space there.

A preferred embodiment is characterized in that the first movable unit, before reaching the first position, and/or the second movable unit, before reaching the second position, is/are detected by the third measurement system. With a predetermined and therefore known movement sequence of the movable unit (for example workpiece support of a transport chain), a later deviation between actual position and desired position can already be avoided in advance.

A preferred embodiment is characterized in that detection of the first movable unit before reaching the first position and/or of the second movable unit before reaching the second position takes place, by means of the third measurement system, at a predetermined point in time with regard to a reference point. This measure increases precision and is particularly advantageous for continuously moving units.

A preferred embodiment is characterized in that the third measurement system detects the position and/or the size and/or the shape of at least one of the movable units and/or the placement or type of a workpiece or tool on at least one of the movable units. The possibility therefore exists to detect not only the movable unit (for example workpiece support of a transport chain) as such, but rather also the position and/or orientation of a workpiece or tool on the movable unit. Because the machine system is directed at processing the workpiece, the data concerning the workpiece are of great importance in determining the relative position. Therefore at least one drive can already have a corresponding setting variable applied to it as a function of the position or orientation of the workpiece, if applicable even before the workpiece support moves into the second position or working position.

In the machine system presented, it is advantageous if the precision and/or resolution of the third measurement system is less than that of the first and/or second measurement system. If the precision/resolution of the first and second measurement device is sufficient to implement a specific precision/resolution of the relative position between the first and the second movable unit, then the third measurement system can have a lower precision/resolution as compared with the first and the second measurement system, without any disadvantage. This particularly holds true if the third measurement system merely provides correction values for the first and/or the second measurement system, and the final position of the first and the second movable unit is moved to using the first and second measurement device. If the first measurement system has a precision/resolution of +/−0.1 mm, for example, and the second measurement system has a precision/resolution of +/−0.2 mm, then a precision/resolution of +/−0.3 mm can be achieved for the predetermined relative position if only the first and the second measurement system are used for position regulation. For the third measurement system, in this case, a precision/resolution of +/−0.3 mm is therefore fundamentally sufficient.

It is also advantageous if the resolution and/or precision of the third measurement system is higher than that of the first measurement system and/or of the second measurement system and/or sum resolution/sum precision of the first and second measurement system. In this manner, the relative position can be determined with greater precision than would be possible using the first and second measurement system. The reason for this is, once again, the error addition already mentioned above. If the first measurement system has a precision/resolution of +/−0.1 mm, for example, and the second measurement system has a precision/resolution of +/−0.2 mm, then a precision/resolution of better than +/−0.3 mm can be reached for the predetermined relative position, if the third measurement system is used for position regulation and the resolution/precision of the third measurement system is greater than the sum resolution/sum precision of the first and second measurement system, in this case, therefore, better than +/−0.3 mm. Furthermore preferably, the resolution/precision of the third measurement system is higher than that of the second measurement system (in other words better than +/−0.2 mm) or even higher than that of the first measurement system (in other words better than +/−0.1 mm). This variant is therefore particularly practical if the position regulation of the first and/or second movable unit takes place using the third measurement system.

It is furthermore particularly advantageous if the first and/or second measurement system is/are structured as a discontinuous measurement system and the third measurement system is structured as a continuous measurement system.

In a “discontinuous” measurement system, physical variables are detected in the form of a step function (digital). An example is a length measurement system or angle measurement system that works on the basis of a bar code. If the width of a bar is known, only the number of bars moving past needs to be counted, in order to thereby obtain a length measurement value or an angle measurement value. This value simply corresponds to the bar width multiplied by the number of bars moving past. For example, such discontinuous length measurement systems or angle measurement systems can be structured as incremental encoders or absolute value encoders. While in the case of absolute value encoders, a measured value is clear over the entire measurement range, for example by means of allocation of a clear code, in the case of incremental encoders an additional reference position is required, starting from which the length increments can be counted.

In contrast to “discontinuous” measurement systems, in a “continuous” measurement system a physical variable is detected continuously, in other words without steps (analog). Continuous detection of a physical variable does not, of course, preclude subsequent digitalization of the measured value detected, but detection as such takes place without steps. In this connection, however, detection of a measured value can by no means take place more precisely than physical laws, particularly quantum mechanics, permit.

The said embodiment variant of the machine system now combines the advantages of both measurement systems in advantageous form. While the first and/or second measurement system is/are structured as a discontinuous and therefore very robust measurement system, the third measurement system is structured as a continuous and therefore generally very precise measurement system.

In a further advantageous embodiment of the machine system, the third measurement system comprises at least one sensor from the group of Hall sensor, eddy current distance measurement sensor, magneto-inductive distance sensor, capacitative distance sensor, laser triangulation sensor, position sensitive device, camera distance sensor.

From the state of the art, several types of distance measurement sensors or position sensors are known, some illustrative examples of which have been listed above. In general, the invention is not restricted to these types concretely mentioned, but rather can also be implemented with other measurement principles.

If current flows through a Hall sensor and the sensor is then introduced into a magnetic field that runs perpendicular to the current, the sensor delivers an output voltage that is proportional to the product of magnetic field intensity and current. In contrast to electrodynamic sensors, a Hall sensor delivers a signal even if the said magnetic field is constant. Because the field intensity of a magnet decreases with an increasing distance, the distance of the Hall sensor from the magnet can be determined by way of the field intensity. The third measurement system of the machine system can therefore have a Hall sensor and at least one magnet, wherein

a) the Hall sensor is disposed on the first movable unit and a first magnet is disposed on the second movable unit, or

b) the Hall sensor is disposed at a fixed point (for example machine frame, machine foundation), a first magnet is disposed on the first movable unit, and a second magnet is disposed the second movable unit.

In case a), the relative position of the first movable unit to the second movable unit can therefore be measured directly; in case b), it is determined by means of subtraction of the two measured positions. In case b), the Hall sensor can advantageously be mounted on a non-movable machine part, whereas the movable units are equipped with the magnets, which are hardly at all susceptible to failure.

An eddy current sensor has a resonant circuit that frequently comprises a measurement head that works inductively and a line that essentially acts as a capacitor, and is attenuated by a metallic object. The active resonant circuit generates an alternating magnetic field, the field lines of which exit from the measurement head and generates eddy currents in the metallic object, which currents result in Joule losses. These losses are indirectly proportional to the distance of the metallic object from the measurement head. The third measurement system of the machine system can therefore have an eddy current sensor and at least one metallic object, wherein
a) the eddy current sensor is disposed on the first movable unit and a first metallic object is disposed on the second movable unit, or
b) the eddy current sensor is disposed at a fixed point (for example machine frame, machine foundation), a first metallic object is disposed on the first movable unit, and a second metallic object is disposed on the second movable unit. In case a), the relative position of the first movable unit to the second movable unit can thereby once again be measured directly; in case b), it is determined by means of subtraction of the two measured positions. In case b), the eddy current sensor can advantageously be mounted on a non-movable machine part, whereas the movable units are equipped with the metal objects, which are hardly at all susceptible to failure.

Magneto-inductive distance sensors combine the the evaluation of the magnetic field intensity with the eddy current principle. In this way, linear characteristic lines, to a great extent, can advantageously be achieved over a broad detection range. The cases a) and b) mentioned with regard to the Hall sensor and the eddy current sensor can also be applied analogously in the case of the magneto-inductive distance sensor.

Capacitative sensors are based on the fact that the capacitance or the capacitance change of two electrodes that are displaceable relative to one another is measured. The capacitance or capacitance change is a measure for the distance of the electrodes from one another. In general, the normal distance between the electrodes or their transversal distance (change in the active surface area or in the sectional region of the two electrodes) can be changed for this purpose. The third measurement system of the machine system can therefore have a capacitative distance sensor, wherein

a) a first electrode is disposed on the first movable unit and a second electrode is disposed on the second movable unit, or

b) a first electrode is disposed on the first movable unit, a second electrode is disposed on the second movable unit, and a third electrode is disposed at a fixed point (for example machine frame, machine foundation).

In case a), the relative position of the first movable unit to the second movable unit can therefore be measured directly, once again; in case b), it is determined by means of subtraction of the two measured positions.

In distance measurement by means of laser triangulation, a laser beam is emitted to a measurement object, impacts onto a reflector there, at a certain angle, and is reflected to a receiver in accordance with the law of reflection. The distance between emitter/receiver can be calculated using the position at which the reflected laser beam impacts the receiver. The third measurement system of the machine system can therefore have a laser triangulation sensor and at least one reflector, wherein

a) the emitter and the receiver are disposed on the first movable unit and a first reflector is disposed on the second movable unit, or

b) the emitter and the receiver are disposed at a fixed point (for example machine frame, machine foundation), a first reflector is disposed on the first movable unit, and a second reflector object is disposed on the second movable unit, wherein the laser beam is passed from the emitter, by way of both reflectors, to the receiver, or

c) the emitter is disposed on the first movable unit, the receiver is disposed at a fixed point, and a first reflector is disposed on the second movable unit, or

d) the receiver is disposed on the first movable unit, the emitter is disposed at a fixed point, and a first reflector is disposed on the second movable unit.

In cases a), c), and d), the relative position of the first movable unit to the second movable unit can once again be measured directly, or at least the existence of a specific relative position can be determined; in case b), it is once again determined by means of subtraction of the two measured positions. Once again, the movable units can be equipped with reflectors, which are hardly at all susceptible to failure.

In the above connection, the use of a “position sensitive device” is advantageous. A “position sensitive device” or “position sensitive detector” (PSD) is an optical position sensor (OPS), with which the one-dimensional or two-dimensional position of a light point can measure. For example, for this purpose a large-area photodiode (lateral diode, “position sensitive diode”) can be used, in which a photo-current occurs in the region of the exposure to light, which current flows off in a specific ratio, by way of the contacts that lie at the edges, depending on the light position. From the currents, the location of the exposure to light can be calculated one-dimensionally or two-dimensionally. Alternatively, the PSD can also be used a CCD camera or CMOS camera, particularly a line camera. The “position sensitive device” then corresponds to a camera distance sensor.

In a further advantageous embodiment of the machine system, the third measurement system comprises at least one light source and at least one light-sensitive element, wherein the relative position between the first movable unit and the second movable unit is determined by means of evaluation of a shadow on the at least one light-sensitive element, which shadow is caused by the light emitted by the at least one light source and the first movable unit and/or the second movable unit.

This embodiment can therefore be interpreted as a special form of a “position sensitive device” or “position sensitive detector” (PSD). However, in this connection the beam of light is not bundled but intentionally emitted in wedge shape. Without disruptive objects in the beam of light, the light-sensitive element, which is configured, for example, as a transversal diode, a CCD camera or CMOS camera, is illuminated essentially uniformly or at least in defined manner. If an object is introduced into the beam of light, then this object causes a shadow on the light-sensitive element, which shadow provides information about the position in which the said object is situated in relation to the light source and to the light-sensitive element, respectively.

In such a measurement system of the machine system,

a) the emitter and the receiver can be disposed on the first movable unit, and a first shadow-casting object can be disposed on the second movable unit, or

b) the emitter and the receiver are disposed at a fixed point (for example machine frame, machine foundation), whereas a first shadow-casting object is disposed on the first movable unit, and a second shadow-casting object is disposed on the second movable unit, or

c) the emitter is disposed on the first movable unit, the receiver is disposed at a fixed point, and a first shadow-casting object is disposed on the second movable unit, or

d) the receiver is disposed on the first movable unit, the emitter is disposed at a fixed location, and a first shadow-casting object is disposed on the second movable unit. In this embodiment, the relative position of the first movable unit to the second movable unit can be directly measured in all the cases a) to d), or at least the presence of a specific relative position can be detected. In order to create a clear allocation of movable unit to cast shadow in case b), the shadow-casting objects can have different shapes or different sizes. If the first shadow-casting object casts a larger shadow than the first object, for example, then allocation of the detected shadow to the corresponding movable unit can specifically be determined by way of the size of the shadow.

It is furthermore advantageous if the first movable unit of the machine system is configured as the head of a robot and the second movable unit of the machine system is configured as a workpiece support or tool support. This is an arrangement in which the set of problems mentioned initially, on which the invention is based, frequently occurs and/or becomes particularly evident. In particular, this is the case if, for example, movable units from different manufacturers are combined with one another. For example, a commercially available industrial robot of one manufacturer can be combined with a specially produced workpiece or tool transport system. Positioning errors and problems due to different responsibilities are practically unavoidable. However, these disadvantages can be overcome by providing the third measurement system. The system construction is therefore more flexible, as a whole.

It is furthermore advantageous if multiple workpiece supports or tool supports are connected with one another in ring shape, particularly connected with one another directly, attached to a chain or attached to a cable. The advantages of the method presented and of the measures presented particularly come to bear in this embodiment, because the chain or the cable to which the workpiece supports or tool supports are attached can stretch over time. As a result, the values measured by the second measurement system, in particular, no longer agree with the original conditions, and thereby without taking further measures, a deviation of the actual relative position implemented between the head of the robot and a workpiece support/tool support from the desired relative position comes about. However, this is no longer the case if the third measurement system is provided.

Finally, it is advantageous if the workpiece supports or tool supports are structured as self-moving units, particularly as rail-bound units. Here, too, the advantages of the method presented and of the measures presented particularly come to bear, because self-moving units, even if they are guided on rails, are generally more difficult to position than movable workpiece supports or tool supports driven by way of serial or parallel kinematics, for example. A relative position between robot head and workpiece support can by providing the third measurement system.

A preferred embodiment is characterized in that the first position and/or the second position lies/lie outside of the detection region of the third measurement system. In this way, for example, the first movable unit can be detected by the third measurement system before it reaches the first position and/or the second movable unit can be detected before it reaches the second position.

A preferred embodiment is characterized in that third measurement system is configured for detecting the position and/or the size and/or the shape of at least one of the movable units and/or of the placement or type of a workpiece or tool on at least one of the movable units.

A preferred embodiment is characterized in that the second movable unit is configured as a workpiece support or tool support, and that the workpiece support or tool support is part of a circulating transport chain that comprises multiple workpiece supports or tool supports disposed one behind the other. In this type of transport system, the workpiece supports are coupled in a composite, so that when the position of one support is known, conclusions can also be drawn regarding the position of the other supports.

A preferred embodiment is characterized in that the transport chain has an upper strand that runs forward and a lower strand that runs backward, and that the third measurement system is positioned in such a manner that at least a part of the upper strand, preferably an end region of the upper strand, lies within the detection region of the third measurement system. The upper strand is usually tensed more strongly than the lower strand, so that the determination of position or location becomes more precise when the upper strand is being detected. Furthermore, the work stations are situated along the upper strand. The distance between third measurement system and the individual work stations is therefore less.

A preferred embodiment is characterized in that the third measurement system is disposed on the first movable unit or on the second movable unit. This allows particularly reliable determination of the type and placement of a workpiece, for example, on the workpiece support, which is independent of influence variables that are connected with the movement of the movable unit.

A preferred embodiment is characterized in that the machine system is a production system for the production of a module composed of multiple parts. Here, the principle according to the invention shows to particular advantage, because the greatest precision is required to combine the individual components. The production system can consist, for example, of multiple work stations disposed one behind the other, which each comprise a first movable unit in the form of a manipulation device (robot, gripper, soldering or welding station, etc.). The second movable unit is a transport chain composed of workpiece supports, which conveys the workpieces through the individual work stations.

A preferred embodiment is characterized in that
at least one first drive assigned to the first movable unit is coupled with the first measurement system for moving to the first position,
at least one second drive assigned to the second movable unit is coupled with the second measurement system for moving to the second position, and
the first drive and/or the second drive is/are coupled with the third measurement system for moving to the predetermined relative position.

This allows optimally reaching the predetermined relative position between the movable units.

At this point, it should be noted that the different embodiments of the machine system as well as the advantages resulting from them can also be applied analogously to the method for its operation, and vice versa.

For a better understanding of the invention, it will be explained in greater detail using the following figures. These show:

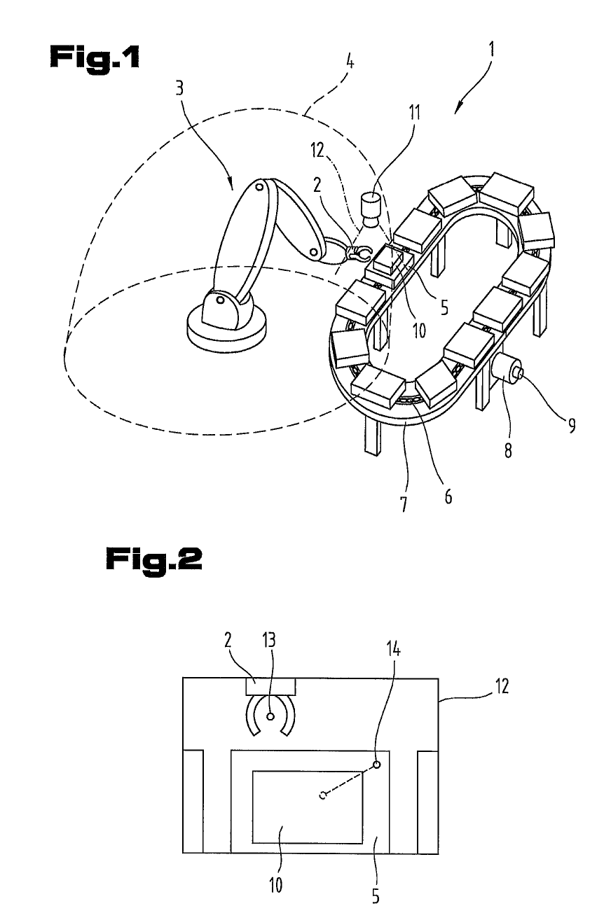

FIG. 1 a schematically represented machine system having a movable robot head, a movable workpiece support, and a camera measurement system;

FIG. 2 an image recorded by the camera measurement system, as an example;

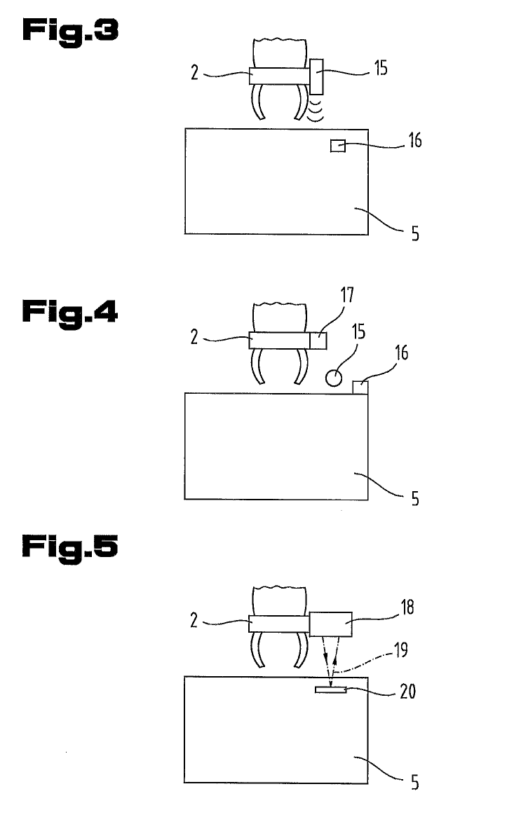

FIG. 3 a third measurement system in the form of a Hall sensor in combination with a magnet;

FIG. 4 a third measurement system in the form of a Hall sensor in combination with two magnets;

FIG. 5 a third measurement system based on laser triangulation;

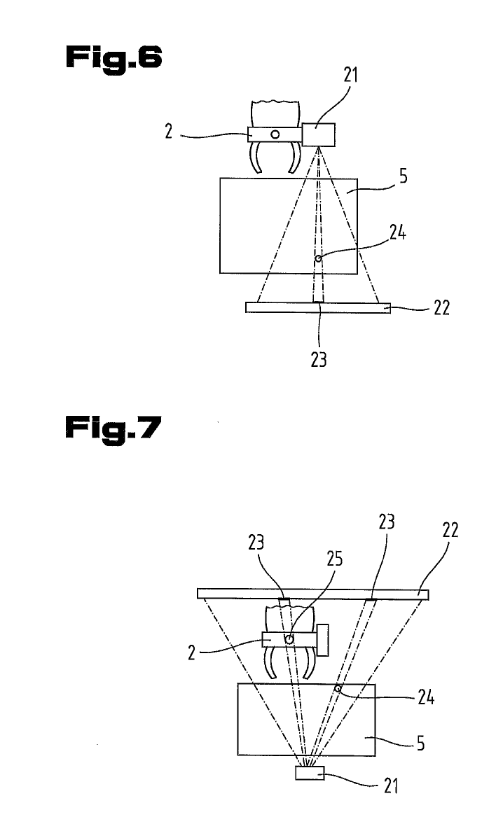

FIG. 6 a third measurement system, in which a shadow cast onto a light-sensitive element is used for determining the relative position between first and second movable unit;

FIG. 7 like FIG. 6, but with two objects on which a shadow is cast;

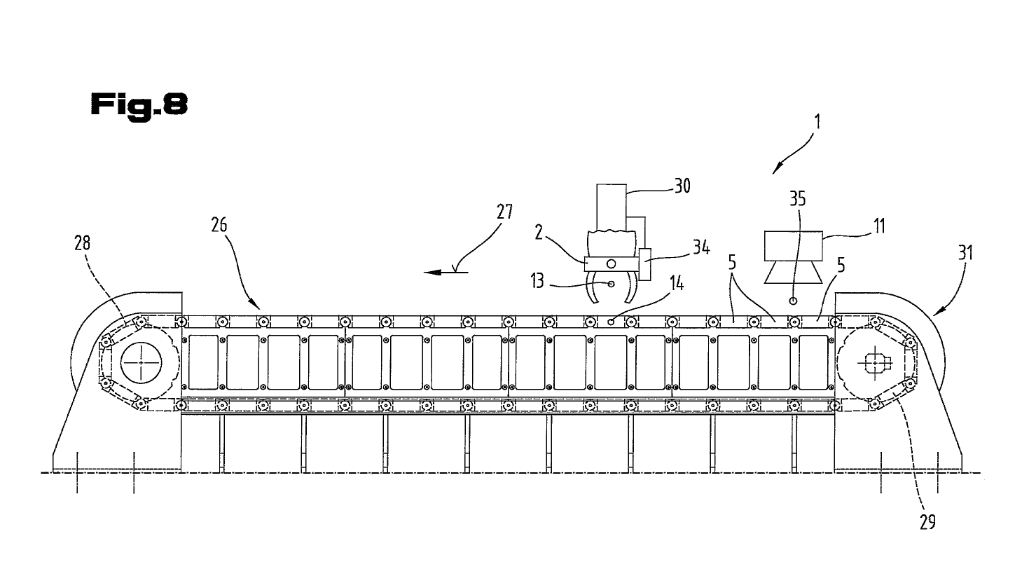

FIG. 8 an exemplary embodiment of the invention with a circulating transport chain;

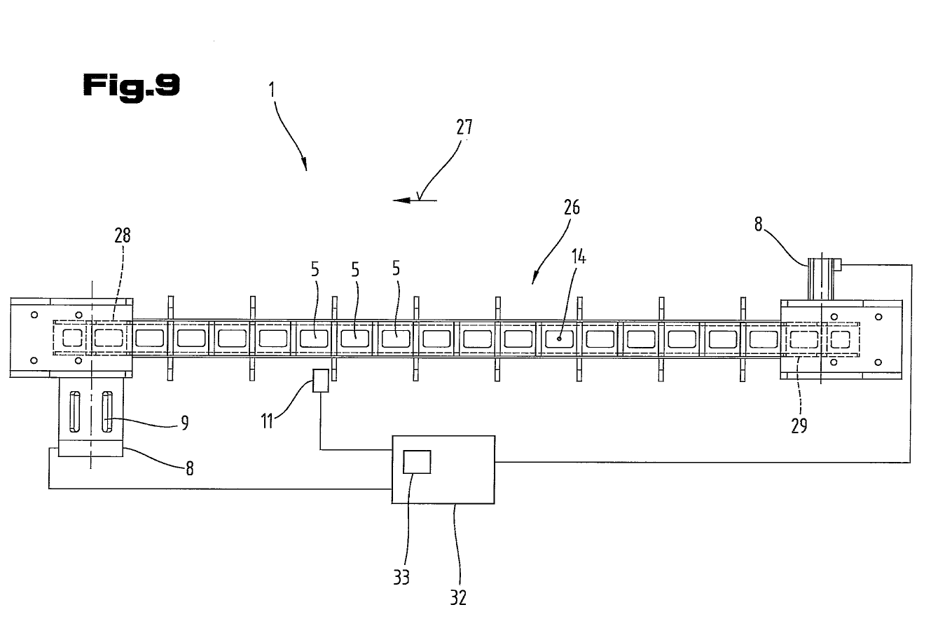

FIG. 9 a further embodiment of the invention, and

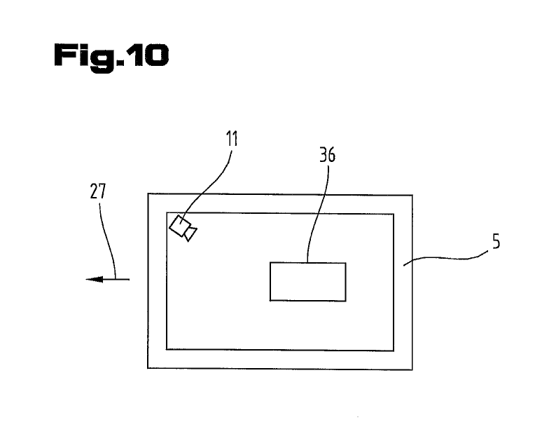

FIG. 10 an embodiment in which the third measurement system is disposed on the movable unit.

As an introduction, it should be stated that in the different embodiments described, the same parts are provided with the same reference symbols of the same component designations, wherein the disclosures contained in the entire description can be transferred analogously to the same parts having the same reference symbols or the same component designations. Also, position information chosen in the description, such as, for example, at the top, at the bottom, at the side, etc., refers to the figure being directly described and shown, and must be transferred analogously to the new position if a change in position occurs. Furthermore, individual characteristics or combinations of characteristics of the different exemplary embodiments shown and described can also represent independent inventive solutions or solutions according to the invention, on their own.

All of the information regarding value ranges in the present description must be understood to mean that these ranges comprise any and all partial ranges within them; for example, the statement 1 to 10 should be understood to mean that all partial regions, starting from the lower limit 1 through the upper limit 10, are included, i.e. all partial ranges start with a lower limit of 1 or greater and end with an upper limit of 10 or less, for example 1 to 1.7 or 3.2 to 8.1 or 5.5 to 10.

FIG. 1 shows a schematically represented machine system 1 having a first movable unit, which is configured, in this example, as a head 2 of a robot 3. The head 2, which is equipped with a gripper here, can be moved in a first movement space 4, here a hemispherical movement space, using at least one first drive.

Using a first measurement system assigned to the first movable unit 3, the first movable unit 2 can be positioned in the first movement space 4, in known manner, at any desired predeterminable position. In concrete terms, in the case of the robot 3 configured as a multi-axial industrial robot, the first measurement system comprises multiple incremental or absolute value encoders, which measure the angles of the individual arm segments relative to one another. In this way, the position of the head 2 can be determined.

Furthermore, the machine system 1 comprises a second movable unit, which is configured as a workpiece support 5 in this example. In this connection, multiple workpiece supports 5 are connected with one another in ring shape, by way of a chain 6, and run on two rails 7 disposed on elevated manner. The workpiece supports 5 can be moved in a second movement space, here configured in ring shape, using a second drive 8. Using a second measurement system assigned to the second movable unit 5, which system is configured as an angle of rotation encoder 9 in this example, the second movable unit 5 can be positioned in any desired predeterminable position in the second movement space. In this example, a workpiece 10 is disposed on one of the workpiece supports 5.

Furthermore, the machine system 1 comprises a third measurement system 11, the detection region 12 of which lies in an overlap region of the first movement space 4 and the second movement space, and is set up for determining a relative position between the first movable unit (robot head) 2 and the second movable unit (workpiece support) 5. In this example, the third measurement system is configured as a camera measurement system 11.

FIG. 2 shows an example of an image recorded by the camera measurement system 11. In this image, the robot head 2 can be seen, the first reference point of which, disposed in the gripper, lies at a first position 13. Furthermore, the workpiece support 5 with the workpiece 10 disposed on it can be seen. A second reference point, disposed on the workpiece support 5, lies at the second position 14.

Proceeding from the second reference point, the desired relative position of the first reference point is shown with a broken line. If possible, the robot head 2 and the workpiece support 5 are therefore supposed to be brought into the relative position to one another shown with a broken line. For this purpose, the robot head 2 can be moved somewhat down and to the right. Alternatively, of course, it is also conceivable that the robot head 2 is moved only downward and the workpiece support 5 is moved to the left. Any desired combinations are conceivable here. When the predetermined relative position has been reached, the robot head 2 performs predefined work on the workpiece 10.

Thereby the method for positioning a first movable unit (robot head) 2 of a machine system 1 and a second movable unit (workpiece support) 5 of the machine system 1 in a predeterminable relative position to one another comprises the steps:
moving the robot head 2 to a first position 13 within a first movement space 4, using a first measurement system,
moving the workpiece support 5 to a second position 14 within a second movement space, using a second measurement system 9, wherein the first position 13 and the second position 14 lie within a detection region 12 of a third measurement system (camera) 11, and
moving the robot head 2 and/or the workpiece support 5 to the said predetermined relative position, using the camera measurement system 11.

Several possibilities now exist for this purpose. For example, the first drives of the robot 3 can be coupled with the first measurement system, for moving to the first position 13,
the second drive 8 can be coupled with the second measurement system 9, for moving to the second position 14, and
the first drives and/or the second drive 8 can be coupled with the camera measurement system 11, particularly exclusively with the camera measurement system 11, for moving to the predetermined relative position.

For this purpose, the machine system 1 comprises means for coupling
the first drives with the camera measurement system 11, alternatively/additionally to the first measurement system, and/or
the second drive 8 with the camera measurement system 11, alternatively/additionally to the second measurement system 9.

On the one hand, it is now possible to determine correction values for the first measurement system and/or second measurement system 9, using the camera measurement system 11, and to move to the corrected first position 13 and/or second position 14, using the first measurement system and/or the second measurement system 9. It is advantageous that for this purpose, drive regulation of the machine system practically does not need to be changed, because using the camera measurement system 11, only adapted desired values for the first measurement system and/or second measurement system 9 are predetermined. In general, the resolution and/or precision of the camera measurement system 11 can be lower, in this connection, than that of the first measurement system and/or second measurement system 9, because the robot head 2 and the workpiece support 5 are not positioned more precisely than the sum resolution/sum precision of the first measurement system and/or second measurement system 9 allow. If the first measurement system, for example, has a precision/resolution of +/−0.1 mm, and the second measurement system 9 has a precision/resolution of +/−0.2 mm, then a precision/resolution of +/−0.3 mm can be achieved for the predetermined relative position. In this case, a precision/resolution of +/−0.3 mm is fundamentally sufficient for the camera measurement system 11.

It is also conceivable, however, that the first drives and/or the second drive 8 of the machine system 1 are uncoupled from the first measurement system and/or second measurement system 9, and instead coupled with the camera measurement system 11. As a result, position regulation then takes place directly by way of the camera measurement system 11. The resolution and/or precision of the camera measurement system 11 is then advantageously higher than that of the first measurement system and/or of the second measurement system 9 and/or sum resolution/sum precision of the first measurement system and the second measurement system 9. In this case, the achievable resolution/precision of the relative position depends, after all, only on the precision/resolution of the camera measurement system 11. With the values mentioned above for the first measurement system and/or the second measurement system 9, the precision/resolution of the camera measurement system 11 is preferably better than +/−0.3 mm. It is furthermore preferred that the precision/resolution of the camera measurement system 11 is higher than that of the second measurement system 9 (in other words better than +/−0.2 mm), or actually higher than that of the first measurement system (in other words better than +/−0.1 mm).

Finally, mixed forms of the two stated methods are also possible. For example, both the values determined by the first/second measurement system 9 and the values determined by the camera measurement system 11 can be used for position regulation. Under some circumstances, the positioning precision can be significantly improved as compared with a method in which only the first/second measurement system 9 or only the camera measurement system 11 is used. As an example, let it be assumed once again that all the measurement systems have a precision/resolution of +/−0.1 mm. If the “scales” of the first/second measurement system 9 and of the camera measurement system 11 are shifted relative to one another, particularly by 0.05 mm, then the precision/resolution can be increased to +/−0.05 mm by means of simultaneous use of the measurement values of the first/second measurement system 9 and of the camera measurement system 11.

In general, the relative position of the robot head 2 to the workpiece support 5 can be is measured directly by means of the camera measurement system 11, as shown in FIG. 2. As a result, the deviation of the actual relative position from the desired relative position is maximally as great as the precision/resolution of the camera measurement system 11. If the precision/resolution lies at +/−0.1 mm, for example, then the relative position can be determined with a precision/resolution of +/−0.1 mm.

However, the relative position of the robot head 2 to the workpiece support 5 can also be determined by means of measuring the position of the robot head 2 relative to a reference point and by measuring the position of the workpiece support 5 relative to this reference point, and subsequent subtraction of the two positions. In FIG. 2, for example, a reference point that lies outside of the robot head 2 and the workpiece support 5 can be used for this purpose.

In an advantageous embodiment, the measured values of the first and/or second measurement system 8 when the predetermined relative position is reached are stored in memory as a future first and/or second position. If a renewed positioning procedure takes place, the first position 13 to which the robot head 2 moves and the second position to which the workpiece support 5 moves will already lie in a predetermined relative position to one another or will at least correspond to this position, to a great extent. Repositioning by means of the camera measurement system 11 will therefore not be necessary or only necessary to a slight extent. Furthermore, it is ensured, in this manner, that the first position 13 and the second position 14 cannot “migrate beyond” the measurement region or detection region 12 of the camera measurement system 11 over the course of time, as the result of temperature-related or plastic deformations of the components involved, as well as aging phenomena and sensor drift of the first measurement system and/or second measurement system 9.

FIG. 3 now shows an example in which the third measurement system comprises a Hall sensor 15, which is affixed to the head 2 of the robot 3. A magnet 16 is disposed on the workpiece support 5. Using the Hall sensor 15, the relative position to the magnet 16 and thereby the relative position between robot head 2 and workpiece support 5 can now be measured directly, in known manner.

In a further variant, shown in FIG. 4, the machine system 1 comprises a Hall sensor 15 mounted in fixed manner, and a magnet 16 mounted on the workpiece support 5, as well as a magnet 17 mounted on the robot head 2. The relative position between the magnets 16 and 17 and thereby the relative position between robot head 2 and workpiece support 5 can be determined by means of subtraction of the positions of the magnets 16 and 17 measured by the Hall sensor.

Other sensors can also be used in similar manner to that shown in FIGS. 3 and 4, for example eddy current distance measurement sensors, magneto-inductive distance sensors, as well as capacitative distance sensor. In the case of an eddy current distance measurement sensor, for example, the measurement head takes the place of the Hall sensor 15, and a metallic object to be detected takes the place of the magnet 16 or of the magnet 17, respectively. In the case of a capacitative distance sensor, electrodes can be provided on the corresponding components of the machine system 1, analogously.

FIG. 5 shows a variant of the machine system 1, in which the relative position between robot head 2 and workpiece support 5 is determined using laser triangulation. For this purpose, a laser emission/reception module 18 is disposed on the robot head, with which module a laser beam 19 is directed at a reflector 20 mounted on the workpiece support 5. Once again, a conclusion regarding the relative position between robot head 2 and workpiece support 5 can be drawn by means of evaluation of the position of the laser beam 19 received by the laser emission/reception module 18.

FIG. 6 shows a further variant for determining the relative position between robot head 2 and workpiece support 5. For this purpose, the third measurement system comprises a light source 21, which is mounted on the robot head 2, and an elongated, light-sensitive element 22, which is mounted in stationary manner. The light-sensitive element 22 can be configured, for example, as a transversal diode, a CCD camera or CMOS camera. In this example, the relative position between robot head 2 and workpiece support 5 is determined by means of evaluation of the shadow 23 on the light-sensitive element 22, which shadow is caused on the workpiece support 5 by the light emitted by the light source 21 and a first shadow-casting object 24, here configured as a bolt. By means of providing multiple light sources 21 and light-sensitive elements 22 oriented transverse to one another, the relative position between robot head 2 and workpiece support 5 can also be determined in multiple dimensions. The same also holds true, of course, if a light-sensitive element 22 that can be evaluated in multiple dimensions is used. For example, the shadow-casting object 24 can have a tip or a hole, the position of which, on such a light-sensitive element 22, can also be detected in two dimensions.

FIG. 7 now shows an embodiment of the machine system 1 that is very similar to the machine system 1 shown in FIG. 6. In contrast to it, however, the light source 21 is disposed in stationary manner, and a second shadow-casting object 25 is situated on the robot head 2. Once again, the relative position of the robot head 2 to the workpiece support 5 can be determined by means of evaluating the shadow case by the objects 24 and 25. It is advantageous that the sensitive measurement system can be disposed at a protected location, while the robot head 2 and the workpiece support 5 are equipped with the shadow-casting objects 24 and 25, which are relatively rugged.

In order to create a clear assignment of movable unit 2, 5 to cast shadow 23, the shadow-casting objects 24 and 25 can be shaped differently or have a different size. If the first shadow-casting object 24 produces a larger shadow 23 than the second shadow-casting object 25, for example, then the assignment of detected shadow 23 to the corresponding movable unit 2, 5 can be determined specifically by way of the size of the shadow 23. It is also conceivable, of course, that the movement of a shadow-casting object 24, 25 is used for the said assignment. If, for example, the robot head 2 is moved, but the workpiece support 5 is not, then the moving shadow 23 is assigned to the robot head 2, while the fixed shadow is assigned to the workpiece support 5.

Alternatively to the embodiments shown in FIGS. 6 and 7,
the light source 21 can be disposed on the robot head 2, the light-sensitive element 22 can be disposed at a fixed point, and a first shadow-casting object 24 can be disposed on the workpiece support 5, or
the light-sensitive element 22 is disposed on the robot head 2, the light source 21 is disposed at a fixed point, and a first shadow-casting object 24 is disposed on the workpiece support 5. Of course, the roles of the robot head 2 and of the workpiece support 5 can also be interchanged in the above examples.

It is also advantageous if the first and/or second measurement system 9 is/are structured as a discontinuous measurement system, and the third measurement system 11, 15 . . . 25 is structured as a continuous measurement system.

In a “discontinuous” measurement system, physical variables are detected in the form of a step function (digital), as is the case, for example, in the first measurement system of the robot 3 and the angle of rotation encoder 9. In contrast to “discontinuous” measurement systems, in a “continuous” measurement system a physical variable is detected continuously, in other words without steps (analog).

For example, the Hall sensor 15, an eddy current distance measurement sensor, a magneto-inductor distance sensor, a capacitative distance sensor, the laser triangulation sensor 18, and the light-sensitive element 22 can the relative position between robot head 2 and workpiece support 5 continuously. This is also possible in the case of the camera 11, provided it is configured as an analog camera. CMOS cameras and CCD cameras, in contrast, must be classified with the discontinuous systems, because of the discrete pixels.

The advantages of the two systems can be combined in that the first and/or second measurement system 9 is/are structured as a discontinuous and thereby very robust measurement system, if the third measurement system 11, 15 . . . 25 is structured as a continuous and thereby generally very precise measurement system.

In the preceding examples, the second movable unit was configured as a workpiece support 5. Of course, the second movable unit can also have a different construction and can be configured, for example, as a tool support. In this case, a milling spindle can be disposed on the head 2 of the robot 3, and the tool supports, which are connected with one another in ring shape, can represent a tool magazine for the robot 3.

Furthermore, the workpiece supports 5 do not have to be connected with one another by way of a chain. Instead, they can also be connected with one another by way of a cable, or actually directly. In a further embodiment, the workpiece supports 5 can also be structured as self-moving units and can travel on the rails 7 or actually freely on a travel surface, for example.

Of course, the robot 3 also does not have to have the construction shown. Instead, it can be structured as a portal robot or can have a parallel-kinematic drive in place of the serial-kinematic drive shown, for example.

In FIGS. 8 and 9, further embodiments of a machine system 1 are shown. The second movable unit is configured as a workpiece support 5 or tool support, wherein the workpiece support 5 or tool support 5 is part of a circulating transport chain 26, which comprises multiple workpiece supports 5 or tool supports disposed one behind the other. The transport chain 26 has an upper strand that runs forward and a lower strand that runs backward. The third measurement system 11 is positioned in such a manner that at least a part of the upper strand—in the embodiment shown, this is an end region of the upper strand, which lies “upstream” from the second position 14 with regard to the conveying direction 27—lies within the detection region of the third measurement system 11. Of course, a “downstream” placement of the third measurement system 11 is also possible with reference to the second position 14, as can be seen in FIG. 9.

Detection of the second movable unit 5 before it reaches the second position 14, by means of the third measurement system 11, can take place at a predetermined point in time with regard to a reference point 35 (FIG. 8). This point can be a target mark that is also detected by the optical detection apparatus 11, or it is simply predetermined by the fixed position of the optical detection apparatus 11. The system can control the transport chain 26 (or also the robot head 2), on the basis of the relative position of a workpiece support 5 to the reference point 35, in such a manner that the desired relative position between the movable units 2, 5 is reached in reliable manner and with great precision.

FIG. 9, in a view from above, shows a variant in which the third measurement system 11 is disposed next to a transport chain 26 and at a slight distance from the end region of the upper strand.

The transport chain 26 is guided, by way of shape fit, by deflection wheels 28, 29 mounted on a basic frame 31 so as to rotate. The transport chain 26 comprises chain links connected with one another in articulated manner, by way of articulation axles, which links form the workpiece supports 5 or tool supports. The articulated axle connects two consecutive workpiece supports 5, in each instance, and runs parallel to the axis of rotation of the deflection wheels 28, 29.

The third measurement system 11, which is preferably configured as an optical detection apparatus, particularly as a camera, is connected with a control apparatus 32, which can comprise an evaluation unit 33. The control apparatus 32 in turn is connected with the (second) drive 8 of the transport chain 26. The drive 8 comprises an advancing drive at one deflection wheel 28 and a braking drive at the other deflection wheel 29. A second measurement system 9 is provided on or integrated into at least the advancing drive (FIG. 9).

The first movable unit 2 is configured as a manipulation apparatus, particularly as a robot head. The drive 30 that moves the first movable unit 2 is indicated purely schematically in FIG. 9. This drive is coupled with the first measurement system 34, which is also represented only purely schematically. The first measurement system 34 can comprise, as has already been mentioned, an incremental or absolute value encoder at the movement axles for the second movable unit.

This represents a possibility that
at least a first drive 30 assigned to the first movable unit 2 is coupled with the first measurement system 34, for moving to the first position 13,
at least a second drive 8 assigned to the second movable unit 5 is coupled with the second measurement system 9, for moving to the second position 14, and
the first drive 30 and/or the second drive 8 is/are coupled with the third measurement system 11, for moving to the predetermined relative position.

In the exemplary embodiments of FIGS. 8 and 9, the first position 13 and the second position 14 lie outside of the detection region of the third measurement system 11. The second movable unit (5) is now detected by the third measurement system 11 even before the second position 14 has been reached. As a result, not only can data concerning the second movable unit 5 (here: workpiece support) be obtained and made available to the machine system, but also data about movable units 5 that are moving past, because they are at a distance from one another that is predetermined by way of the transport chain 26 and essentially cannot change. Thereby, a conclusion can be drawn, by way of detection of an individual workpiece support or tool support, regarding the current position of the other workpiece support or tool support comprised by the transport chain 26.

The third measurement system 11 can be configured for detection of the position and/or the size and/or the shape of at least one of the movable units 2, 5 and/or of the placement of a workpiece or tool on at least one of the movable units 2, 5.

It would likewise be conceivable that the third measurement system 11 is disposed, at least in part, on the first movable unit 2 or on the second movable unit 5, or travels along with it (FIG. 10). Such a solution is particularly suitable if the position and/or orientation of a workpiece, component or tool on the movable unit 5 is/are supposed to be detected. FIG. 10 shows a workpiece support 5 that is moved along a conveying direction. The third measurement system 11, which is configured as an optical detection device in this case, can detect the placement, particularly the position and/or orientation of a workpiece 36 on the workpiece support 5. From these data, the desired relative position (for example for grasping the workpiece 36 by means of a robot head 2) can be determined and moved to with great precision.

Preferably, the machine system is a production system for the production of a module composed of multiple parts. Of course, multiple, also different manipulation apparatuses can be disposed next to one another along the transport chain 26. These form individual work stations, to which the workpiece supports are transported, one after the other. Thus, in FIG. 8, for example, multiple robot heads 2 could be disposed next to one another. The data detected by the third measurement system 11 can be passed on to all the manipulation apparatuses, so that these can be controlled on the basis of the data.

The exemplary embodiments show possible embodiment variants of a machine system 1 according to the invention, where it should be noted, at this point, that the invention is not restricted to the embodiment variants of it specifically shown, but rather instead, various combinations of the individual embodiment variants with one another are also possible, and this variation possibility lies within the ability of a person skilled in the art of this field, on the basis of the teaching for technical action provided by the present invention. Therefore, all conceivable embodiment variants that are possible by means of combining individual details of the embodiment variant shown and described are also covered by the scope of protection.

In particular, it is stated that the machine systems 1 shown can, in reality, also comprise more or fewer components than shown.

For the sake of good order, it should be pointed out, in conclusion, that the machine systems 1, as well as their components, have been shown not to scale and/or magnified and/or reduced in size, in part, for a better understanding of their structure.

The task on which the independent inventive solutions are based can be derived from the description.

### Reference Symbol List

1 machine system
2 first movable unit (robot head)
3 robot
4 first movement space
5 second movable unit (tool support)
6 chain
7 rails
8 second drive
9 second measurement system (angular position encoder)
10 workpiece
11 third measurement system (camera)
12 detection region of the third measurement system
13 first position
14 second position
15 Hall sensor
16 magnet
17 magnet
18 laser transmission/reception module
19 laser beam
20 reflector
21 light source
22 light-sensitive element
23 shadow
24 first shadow-casting object
25 second shadow-casting object
26 transport chain
27 conveying direction
28 deflection wheel
29 deflection wheel
30 first drive
31 basic frame
32 control apparatus
33 evaluation unit
34 first measurement system
35 reference point
36 workpiece

1-28. (canceled)

29. A method for positioning a first movable unit (2) of a machine system (1) and a second movable unit (5) of the machine system (1) in a predeterminable relative position to one another, comprising the steps:
moving the first movable unit (2) to a first position (13) within a first movement space (4), using a first measurement system,
moving the second movable unit (5) to a second position (14) within a second movement space, using a second measurement system (9),
wherein
the first movable unit (2) and/or the second movable unit (5) is/are moved to the said predetermined relative position, using a third measurement system (11, 15 . . . 25), and wherein the first position (13) and the second position (14) lie outside of the detection region of the third measurement system (11, 15 . . . 25), and wherein the third measurement system (11, 15 . . . 25) is not disposed in the common working region of the movable units (2, 5), and wherein the second movable unit is configured as a workpiece support (5) or tool support, and wherein the workpiece support (5) or tool support is part of a circulating transport chain (26) that comprises multiple workpiece supports (5) or tool supports disposed one behind the other, which are coupled in a composite.

30. The method according to claim 29, wherein
at least one first drive assigned to the first movable unit (2) is coupled with the first measurement system, for moving to the first position (13),
at least one second drive (8) assigned to the second movable unit (5) is coupled with the second measurement system (9), for moving to the second position (14), and
the first drive and/or the second drive (8) is/are coupled with the third measurement system (11, 15 . . . 25), for moving to the predetermined relative position.

31. The method according to claim 29, wherein the relative position of the first movable unit (2) to the second movable unit (5) is measured directly by the third measurement system (11, 15 . . . 25).

32. The method according to claim 29, wherein the relative position of the first movable unit (2) to the second movable unit (5) is determined by measuring the position of the first movable unit (2) relative to a reference point and by measuring the position of the second movable unit (5) relative to this reference point, by means of the third measurement system (11, 15 . . . 25), and subsequent subtraction of the two positions.

33. The method according to claim 29, wherein the measured values of the first and/or second measurement system (9) when the predetermined relative position is reached are stored as a future first and/or second position (13, 14).

34. The method according to claim 29, wherein the first movable unit (2), before reaching the first position (13), and/or the second movable unit (5), before reaching the second position (14), is/are detected by the third measurement system (11, 15 . . . 25).

35. The method according to claim 34, wherein detection of the first movable unit (2) before reaching the first position (13) and/or of the second movable unit (5) before reaching the second position (14) takes place, by means of the third measurement system (11, 15 . . . 25), at a predetermined point in time with regard to a reference point (35).

36. The method according to claim 29, wherein the third measurement system detects the position and/or the size and/or the shape of at least one of the movable units (2, 5) and/or the placement of a workpiece (5) or tool on at least one of the movable units (2, 5).

37. The method according to claim 29, wherein the machine system (1) is a production system for production of a module composed of multiple parts.

38. The method according to claim 37, wherein the production system comprises multiple work stations disposed one behind the other, which each comprise a first movable unit in the form of a manipulation device, wherein preferably, the second movable unit is a transport chain composed of workpiece supports, which conveys the workpieces through the individual work stations.

39. The method according to claim 38, wherein the information detected by the third measurement system is passed on to all the manipulation devices, so that these can be controlled on the basis of this information.

40. A machine system (1), comprising
a first movable unit (2) that can be moved in a first movement space (4), using at least a first drive,
a first measurement system assigned to the first movable unit (2), using which system the first movable unit (2) can be positioned in any desired predeterminable position in the first movement space (4),
a second movable unit (5) that can be moved in a second movement space, using at least a second drive (8), wherein the first movement space (4) and the second movement space (8) demonstrate an overlap region,
a second measurement system (9) assigned to the second movable unit (5), using which system the second movable unit (5) can be positioned in any desired predeterminable position in the second movement space,
a third measurement system (11, 15 . . . 25) that is set up for determining a relative position between the first movable unit (2) and the second movable unit (5), wherein the first position (13) and the second position (14) lie outside of the detection region of the third measurement system (11, 15 . . . 25), and wherein the third measurement system (11, 15 . . . 25) is not disposed in the common working region of the movable units (2, 5), and wherein the second movable unit is configured as a workpiece support (5) or tool support, and wherein the workpiece support (5) or tool support is part of a circulating transport chain (26) that comprises multiple workpiece supports (5) or tool supports disposed one behind the other, which are coupled in a composite.

41. The machine system (1) according to claim 40, further comprising means for coupling
the first drive with the third measurement system (11, . . . 15 25), alternatively/additionally to the first measurement system, and/or
the second drive (9) with the third measurement system (11, 15 . . . 25), alternatively/additionally to the second measurement system (9).

42. The machine system (1) according to claim 40, wherein multiple workpiece supports (5) or tool supports are connected with one another in ring shape, particularly directly connected with one another, attached to a chain (6) or attached to a cable.

43. The machine system (1) according to claim 40, wherein the workpiece supports (5) or tool supports are structured as self-moving units.

44. The machine system according to claim 40, wherein the third measurement system (11) is configured for detecting the position and/or the size and/or the shape of at least one of the movable units (2, 5) and/or the placement or type of a workpiece or tool on at least one of the movable units (2, 5), wherein preferably, the transport chain (26) has an upper strand that runs forward and a lower strand that runs backward, and wherein the third measurement system (11) is positioned in such a manner that at least a part of the upper strand, preferably an end region of the upper strand, lies within the detection region of the third measurement system (11).

45. The machine system according to claim 40, wherein the third measurement system (11) is disposed on the first movable unit (2) or on the second movable unit (5).

46. The machine system according to claim 40, wherein the machine system (1) is a production system for the production of a module composed of multiple parts.

47. The machine system according to claim 46, wherein the production system comprises multiple work stations disposed one behind the other, which each comprise a first movable unit in the form of a manipulation device, wherein preferably, the second movable unit is a transport chain composed of workpiece supports, which conveys the workpieces through the individual work stations.

48. The machine system according to claim 40, wherein
at least one first drive (30) assigned to the first movable unit (2) is coupled with the first measurement system (34) for moving to the first position (13),
at least one second drive (8) assigned to the second movable unit (5) is coupled with the second measurement system (9) for moving to the second position (14), and
the first drive and/or the second drive (8) is/are coupled with the third measurement system (11, 15 . . . 25) for moving to the predetermined relative position.
